(19) United States
(12) Patent Application Publication
(10) Pub. No.: US 2023/0307661 A1
(43) Pub. Date: Sep. 28, 2023

(54) CATALYST LAYER

(71) Applicants: KABUSHIKI KAISHA TOYOTA CHUO KENKYUSHO, Nagakute-shi (JP); TOYOTA JIDOSHA KABUSHIKI KAISHA, Toyota-shi (JP)

(72) Inventors: Masanori INABA, Nagakute-shi (JP); Tomohiro Takeshita, Nagakute-shi (JP); Kensaku Kodama, Nagakute-shi (JP); Takeshi Nobukawa, Toyota-shi (JP)

(73) Assignees: KABUSHIKI KAISHA TOYOTA CHUO KENKYUSHO, Nagakute-shi (JP); TOYOTA JIDOSHA KABUSHIKI KAISHA, Toyota-shi (JP)

(21) Appl. No.: 18/184,409

(22) Filed: Mar. 15, 2023

(30) Foreign Application Priority Data
Mar. 22, 2022 (JP) 2022-045239

(51) Int. Cl. H01M 4/88; H01M 4/90; H01M 4/92

(52) U.S. Cl. CPC H01M 4/8892; H01M 4/9033; H01M 4/92

(57) ABSTRACT

A catalyst layer includes an electrode catalyst and an ionomer. The electrode catalyst includes: tin oxide-based particles having a structure (connected structure) in which porous primary particles are connected to each other in a bead shape and having a specific surface area of 30 m²/g or more; and Pt-based fine particles supported on the surface of the tin oxide-based particles. The conductivity of a green compact composed of the tin oxide-based particles is desirably 1×10⁻³ S/cm or more. As the tin oxide-based particles, those composed of Sb-doped SnO₂ and having a specific surface area of 90 m²/g or more and a pore diameter of 5 nm or more and 8 nm or less are desired.

### FIELD OF THE INVENTION

The present invention relates to a catalyst layer, and more specifically to a catalyst layer equipped with an electrode catalyst having Pt-based fine particles supported on the surface of tin oxide-based particles.

### BACKGROUND OF THE INVENTION

A polymer electrolyte fuel cell (PEFC) has a membrane electrode assembly (MEA) in which a catalyst layer is bonded to both sides of an electrolyte membrane. A gas diffusion layer is usually arranged outside a catalyst layer. Further, a current collector (separator) with a gas flow path is arranged outside the gas diffusion layer. PEFC usually has a structure (a fuel cell stack) in which a plurality of unit cells, each of the unit cells including such an MEA, gas diffusion layers, and current collectors, are stacked.

In PEFC, the catalyst layer is usually composed of a mixture of an electrode catalyst having catalyst metal fine particles such as platinum supported on the surface of a support and a catalyst layer ionomer. As a catalyst support, carbon materials such as carbon black and acetylene black have conventionally been used mainly. In particular, a carbon support having mesopores has recently attracted attentions (Non-Patent Literature 1). It has been understood that by using, as a support, porous carbon particles having a properly controlled particle diameter and pore diameter, both a reduction in poisoning of a catalyst by a sulfonic acid group of the ionomer and a reduction in Knudsen diffusion resistance in support pores can be satisfied and therefore, cell performance capable of achieving both low load performance and high load performance can be obtained (Patent Literature 1).

It has however been known that the carbon support exposed to a high potential causes oxidation corrosion and the catalyst metal fine particles supported on the support fall off and thereby the electrode inevitably has deteriorated performance. Therefore, use of a conductive metal oxide stable at a high potential has been proposed as a support material.

For example, Non-Patent Literature 2 discloses that:
(a) among various conductive metal oxides, a nonstoichiometric titanium oxide (TiOx) or tin oxide doped with a foreign element (such as Nb or Sb) is promising as a catalyst support, and
(b) particularly for a catalyst support for the cathode of PEFC, tin oxide stable under strongly acidic and high-potential environments is promising.

Patent Literature 2 discloses an electrode catalyst obtained by forming a coating film composed of F-doped SnO₂ on the surface of a support composed of Sb- and Ta-doped SnO₂ particles and supporting platinum nickel alloy particles on the surface of the coating film.

The literature describes that:
(A) when Sb-doped SnO₂ particles are used as a support, Sb may poison a precious metal-containing catalyst, and
(B) when a coating film composed of F-doped SnO₂ is formed on the surface of a support composed of Sb- and Ta-doped SnO₂ particles, poisoning of a precious metal-containing catalyst by Sb can be suppressed.

Patent Literature 3 discloses an electrode catalyst obtained by:
(a) supplying a solution containing tin octylate and niobium octylate in chemical flame and thereby preparing a support to which primary particles composed of niobium-containing tin oxide have partially been fused and bonded to each other,
(b) supporting platinum and a nonstoichiometric platinum oxide on the surface of the support, and
(c) heat treating the support having platinum and the platinum oxide supported thereon in a hydrogen atmosphere at 150° C. for 2 hours to perform reduction of platinum and alloying of platinum and tin.

The Literature describes that by alloying of tin and platinum, the resulting electrode catalyst has further improved conductivity.

Patent Literature 4 discloses an electrode material for fuel cell obtained by:
(a) preparing SnO₂ particles by an ammonia coprecipitation method,
(b) supporting a Pt oxide on the surface of SnO₂ particles by a colloidal method, and
(c) subjecting the support having a Pt oxide supported thereon to reduction treatment in a 5% H₂/N₂ atmosphere at 100° C. for 2 hours.

The Literature describes that when an SnO₂ support having a precious metal colloid supported thereon is heat-treated at a temperature of 80° C. or higher and 250° C. or lower in a reducing atmosphere, an electrode material for fuel cell having excellent electrochemical catalytic activity can be obtained even if the amount of the precious metal used is small.

Non-Patent Literature 3 discloses an oxygen reduction electrode catalyst in which the surface of antimony-doped tin oxide is modified with Pt. The Literature describes that when the carbon support is replaced by a metal oxide support, the resulting electrode catalyst has improved endurance.

Further, Non-Patent Literature 4 describes the possibility of platinum nanoparticles supported on antimony-doped tin oxide becoming a more stable oxygen reduction catalyst than conventional platinum nanoparticles supported on carbon.

As described above, when a carbon support having mesopores is used for a fuel cell electrode (cathode), poisoning by an ionomer is suppressed and as a result, high initial performance can be achieved. The carbon support has however a problem in durability at high potential. On the other hand, a tin oxide support is excellent in durability at high potential. An example of supporting Pt in the mesopores of a tin oxide support having mesopores and thereby suppressing poisoning by an ionomer has however not been reported. For example, in Patent Literatures 2 to 4 and Non-Patent literature 3, a solid tin oxide support having no mesopores is used.

On the other hand, in Non-Patent Literature 4, a tin oxide support having mesopores is used, but its support structure is not a connected one. In addition, Non-Patent Literature 4 describes that a porous structure is effective for increasing the specific surface area of the support but this literature does not include a description on the suppression of poisoning caused by an ionomer.

### CITATION LIST

### Patent Literatures

Patent Literature 1: Japanese Unexamined Patent Application Publication No. 2021-084852
Patent Literature 2: Japanese Unexamined Patent Application Publication No. 2017-183273
Patent Literature 3: WO2015/050046
Patent Literature 4: WO2009/060582

### Non-Patent Literatures

Non-Patent Literature 1: S. Ott et al., Nature Mater., 2019, 19, 77
Non-Patent Literature 2: T. Arai et al., SAE Int. J. Alt. Power., 2017, 6, 145
Non-Patent Literature 3: Sankarasubramanian et al., ACS Catal., 2021, 11, 7006
Non-Patent Literature 4: Jalalpoor et al., J. Electrochem. Soc., 2021, 168, 024502

### SUMMARY OF THE INVENTION

A problem to be solved by the present invention is to provide a novel catalyst layer equipped with an electrode catalyst having Pt-based fine particles supported on the surface of tin oxide-based particles.

Another problem to be solved by the present invention is to provide a catalyst layer having higher oxygen reduction reaction (ORR) mass activity and higher durability at high-potential cycles than a conventional catalyst layer.

In order to solve the above problems, the catalyst layer according to the present invention has the following constitutions.

(1) The catalyst layer includes:
an electrode catalyst, and
an ionomer.
(2) The electrode catalyst includes:
tin oxide-based particles having a structure (connected structure) in which porous primary particles are connected to each other in a bead shape and having a specific surface area of 30 m²/g or more and
Pt-based fine particles supported on the surface of the tin oxide-based particles.

In a catalyst layer containing an electrode catalyst having Pt-based fine particles supported on the surface of tin oxide-based particles, both high ORR mass activity (high ORR mass activity particularly under a low-humidity environment) and high durability can be satisfied by optimizing microstructure and composition of the tin oxide-based particles. This is probably because:
(a) Pt-based fine particles are supported on the surface (particularly, in the mesopores) of the porous tin oxide-based particles to suppress the Pt-based fine particles from being poisoned by an ionomer,
(b) the surface of the tin oxide-based particles is hydrophilic, which facilitates the retention of water around the tin oxide-based particles even under a low-humidity environment, and
(c) by using the tin oxide-based particles as a support, the resulting catalyst layer has relatively high electronic conductivity and in addition, oxidation corrosion of the support is suppressed.

### BRIEF DESCRIPTION OF THE DRAWINGS

FIG. 1A is a cyclic voltammogram of Pt/Sb—SnO₂ (Examples 1 to 4) and Pt/Vulcan (trademark) (Comparative Example 1) at 60° C. and 80% RH.

FIG. 1B is a cyclic voltammogram of Pt/Sb—SnO₂ (Examples 1 to 4) and Pt/Vulcan (trademark) (Comparative Example 1) at 82° C. and 30% RH.

FIG. 2 is ECSA of Pt/Sb—SnO₂ (Examples 1 to 4) and Pt/Vulcan (trademark) (Comparative Example 1) determined by the CO stripping measurement.

FIG. 3A is an I-V curve of Pt/Sb—SnO₂ (Examples 1 to 4) and Pt/Vulcan (trademark) (Comparative Example 1) at 60° C. and 80% RH.

FIG. 3B is an I-V curve of Pt/Sb—SnO₂ (Examples 1 to 4) and Pt/Vulcan (trademark) (Comparative Example 1) at 82° C. and 30% RH.

FIG. 4A is ORR mass activity (MA) of Pt/Sb—SnO₂ (Examples 1 to 4) and Pt/Vulcan (trademark) (Comparative Example 1) at 0.86 V.

FIG. 4B is ORR area specific activity (SA) of Pt/Sb—SnO₂ (Examples 1 to 4) and Pt/Vulcan (trademark) (Comparative Example 1) at 0.86 V.

FIG. 5A is an I-V curve of Pt/Sb—SnO₂ (0.10 mg_{Pt}/cm², Example 5) before and after a high-potential cycle test (2000 cycles).

FIG. 5B is an I-V curve of Pt/Vulcan (trademark) (0.10 mg_{Pt}/cm², Comparative Example 2) before and after a high-potential cycle test (2000 cycles).

FIG. 6 is a graph showing the relationship between ECSA and the number of high-potential cycles of the cathode catalyst layer obtained in Example 5 and Comparative Example 2.

FIG. 7 is ORR mass activity at 0.86 V before and after a high-potential cycle test (2000 cycles) of the cathode catalyst layer obtained in Example 5 and Comparative Example 2.

### DETAILED DESCRIPTION OF THE PREFERRED EMBODIMENTS

An embodiment of the present invention will hereinafter be described in detail.

### [1. Catalyst Layer]

The catalyst layer according to the present invention includes: an electrode catalyst, and an ionomer.

### [1.1. Electrode Catalyst]

The electrode catalyst includes:
tin oxide-based particles having a structure (connected structure) in which porous primary particles are connected to each other in a bead shape and having a specific surface are of 30 m²/g or more, and
Pt-based fine particles supported on the surface of the tin oxide-based particles.

### [1.1.1. Tin Oxide-Based Particles]

### [A. Composition]

The term “tin oxide-based particles” means particles composed of SnO₂ or particles composed of dopant-containing SnO₂.

In the present invention, the kind of the dopant is not particularly limited. Examples of the dopant include Nb, Sb, W, Ta, and Al. SnO₂ may contain any one of the aforesaid dopants or may contain two or more of them.

Of these, Sb-, Nb-, Ta-, and/or W-doped SnO₂ is preferred as the tin-oxide based particles.

As the tin oxide-based particles, Sb-doped SnO₂ is particularly preferred. The Sb-doped SnO₂ is suited as a catalyst support for supporting Pt-based fine particles thereon because it has higher conductivity than SnO₂ containing another dopant.

In the Sb-doped SnO₂, with an increase in the doping amount of Sb, conductivity becomes higher. To achieve such an effect, the doping amount of Sb is desirably 2.5 at % or more. The doping amount of Sb is more desirably 5.0 at % or more.

When the doping amount of Sb becomes excessive, on the other hand, a carrier concentration becomes excessive, which may lead to deterioration in conductivity. The doping amount of Sb is therefore desirably 15.0 at % or less. The doping amount of Sb is more desirably 10.0 at % or less.

### [B. Specific Surface Area]

Usually, with an increase in the specific surface area, the tin oxide-based particles have improved ORR mass activity because they can support Pt-based fine particles thereon in highly-dispersed form. The tin oxide-based particles having a larger specific surface area are therefore better. To have high ORR mass activity, the tin oxide-based particles are required to have a specific surface area of 30 m²/g or more. The specific surface area is desirably 50 m²/g or more, more desirably 60 m²/g or more, yet more desirably 90 m²/g or more, and still yet more desirably 100 m²/g or more.

### [C. Pore Diameter]

The tin oxide-based particles desirably have therein pores (which may also be called “mesopores” hereinafter) having a pore diameter of 50 nm or less.

The term “mesopores” usually means pores having a diameter of 2 nm or more and 50 nm or less. In the present invention, unless otherwise particularly specified, the term “mesopores” means pores having a diameter of less than 2 nm (so-called “micropores”) in addition to the pores having a diameter of 2 nm or more and 50 nm or less.

The team “pore diameter” means an average diameter of mesopores.

A pore diameter can be determined by analyzing the adsorption side data of a nitrogen adsorption isotherm of tin oxide-based particles and finding a pore diameter (most frequent peak value or mode pore diameter) when the pore volume becomes maximum.

When the tin oxide-based particles have mesopores and Pt-based fine particles are supported thereon, an existing proportion of the Pt-based fine particles in the mesopores increases. Therefore, when Pt-based fine particles are supported in the mesopores of the tin oxide-based particles to form an electrode catalyst and a catalyst layer is formed using the resulting electrode catalyst and an ionomer, poisoning of the Pt-based fine particles by the ionomer and deterioration in performance due to this poisoning can be suppressed.

When the tin oxide-based particles have mesopores, the pore diameter (size of each mesopore) has an influence on the performance of the resulting electrode catalyst. In general, a too small pore diameter makes it difficult to support Pt-based fine particles in the mesopores. As a result, in the catalyst layer formed using the electrode catalyst of the present invention and an ionomer, the Pt-based fine particles may be poisoned by the ionomer. The pore diameter is therefore desirably 1 nm or more. The pore diameter is more desirably 2 nm or more and yet more desirably 5 nm or more.

On the other hand, when the pore diameter becomes too large, the ionomer enters the mesopores and the Pt-based fine particles supported in the mesopores may be poisoned by the ionomer. The pore diameter is therefore desirably 20 nm or less, more desirably 10 nm or less, and yet more desirably 8 nm or less.

Particularly, when a pore diameter of tin oxide-based particles is 5 nm or more and 8 nm or less, high catalytic activity can be obtained when a catalyst layer is manufactured using the tin oxide-based particles as a catalyst support.

### [D. Shape]

In the present invention, the shape of the tin oxide-based particles is not particularly limited as long as it satisfies the aforesaid conditions. The tin oxide-based particles may be isolated from each other or may have a connected structure in which porous primary particles are connected to each other.

The term “connected structure” as used herein means a structure in which primary particles are connected to each other in a bead shape.

Tin oxide-based particles having a connected structure in which porous primary particles are connected to each other can be obtained by the method described later. Since in the particles (meaning secondary particles) having a connected structure, primary particles are sparsely connected to each other, relatively coarse voids are present between the primary particles. Therefore, when an electrode catalyst is formed using tin oxide-based particles having a connected structure and a catalyst layer is formed using the resulting electrode catalyst and an ionomer, adequate voids are formed in the catalyst layer. As a result, the catalyst layer thus obtained has reduced gas diffusion resistance.

The primary particles are composed of an assembly of fine crystallites so that they have therein relatively fine voids (mesopores). By using them as a catalyst support, Pt-based fine particles can be prevented from being poisoned by the ionomer.

The shape of the primary particles is not particularly limited. When the tin oxide-based particles are formed using the method described later, the primary particles are usually not completely spherical and have an irregular shape with an aspect ratio of about 1.1 to 3.

As will be described later, the tin oxide-based particles according to the present invention are manufactured using mesoporous carbon as a template. The mesoporous carbon is manufactured using mesoporous silica as a template. The mesoporous silica is usually synthesized by polycondensing a silica source in a reaction solution containing a silica source, a surfactant, and a catalyst.

During synthesis, by limiting the concentration of the surfactant and the concentration of the silica source in the reaction solution to fall in specific ranges, respectively, mesoporous silica having a connected structure and having a specific surface area, a pore diameter, and the like within a specific range can be obtained.

By using such mesoporous silica having a connected structure as a first template, mesoporous carbon having a connected structure can be obtained. Further, by using the mesoporous carbon having a connected structure as a second template, tin oxide-based particles having a connected structure can be obtained.

### [E. Average Particle Diameter of Primary Particles]

The tam “average particle diameter of primary particles” as used herein means an average value of the maximum diameter of primary particles observed with a scanning electron microscope (SEM).

When the tin oxide-based particles have a connected structure in which porous primary particles are connected to each other, the average particle diameter of the primary particles is not particularly limited and the optimum value can be selected depending on the purpose.

In general, it becomes difficult for primary particles having a too small average particle diameter to support Pt-based fine particles thereon. Therefore, an average particle diameter of the primary particles is desirably 0.05 μm or more. The average particle diameter is more desirably 0.06 μm or more and yet more desirably 0.07 μm or more.

On the other hand, when the primary particles have a too large average particle diameter, the catalyst layer becomes thick and has increased ionic resistance and electronic resistance. Therefore, an average particle diameter of the primary particles is desirably 2 μm or less. The average particle diameter is more desirably 1 μm or less and yet more desirably 0.5 μm or less.

### [F. Conductivity of a Green Compact]

The team “conductivity of a green compact” means a value determined by:
(a) forming tin oxide-based particles with two stainless steel disks and a plastic jig having a cylindrical hole therein, and
(b) measuring a voltage of the resulting green compact while applying a constant current thereto under pressure of 2.4 MPa.

The conductivity of the green compact (meaning, tin oxide-based particles) mainly depends on the kind and amount of the dopant. By optimizing the composition of the tin oxide-based particles, a conductivity of the green compact becomes 1×10⁻³ S/cm or more. By optimizing the manufacturing conditions, the conductivity of the green compact becomes 1×10⁻² S/cm or more.

Even tin oxide-based particles having a conductivity of a green compact of about 10 S/cm can be synthesized by using the method described later.

### [G. Pore Volume]

The tam “pore volume” means the volume of mesopores contained in the primary particles and it does not include the volume of voids between the primary particles.

The pore volume can be obtained by analyzing the adsorption data of the nitrogen adsorption isotherm of tin oxide-based particles by the BJH method and calculating using values at P/P₀=0.03 to 0.99.

When the tin oxide-based particles according to the present invention are used for a catalyst support for PEFC, if the pore volume becomes too small, a proportion of catalyst particles supported in pores decreases. The pore volume is therefore desirably 0.1 mL/g or more. The pore volume is desirably 0.15 mL/g or more and more desirably 0.2 mL/g or more.

On the contrary, if the pore volume becomes too large, the proportion of pore walls of the tin oxide-based particles becomes smaller, leading to a decrease in electronic conductivity. In addition, due to an increase in an invasion amount of an ionomer, the catalyst may be poisoned and therefore have deteriorated activity. The pore volume is therefore desirably 1 mL/g or less. The pore volume is desirably 0.7 mL/g or less and more desirably 0.5 mL/g or less.

### [H. Tap Density]

The term “tap density” means a value measured in accordance with JIS Z 2512.

When the tin oxide-based particles according to the present invention are used for the catalyst layer of PEFC, if the tap density of the tin oxide-based particles becomes too small, the catalyst layer thus obtained has a too large thickness and has deteriorated proton conductivity. The tap density is therefore desirably 0.005 g/cm³ or more. The tap density is desirably 0.01 g/cm³ or more and more desirably 0.05 g/cm³ or more.

On the contrary, if the tap density becomes too large, it is difficult to secure, in the catalyst layer formed using the aforesaid particles, voids capable of suppressing flooding. The tap density is therefore desirably 1.0 g/cm³ or less. The tap density is desirably 0.75 g/cm³ or less.

### [I. Preferred Mode]

Among the tin oxide-based particles satisfying the aforesaid conditions, preferred are those being composed of Sb-doped SnO₂, having a specific surface area of 90 m²/g or more, and having a pore diameter of 5 nm or more and 8 nm or less. A catalyst layer famed using, for a support, tin oxide-based particles that satisfy such conditions has high catalytic activity.

### [1.1.2. Pt-Based Fine Particles]

### [A. Composition]

The term “Pt-based fine particles” means fine particles composed of Pt or a Pt alloy. The Pt-based fine particles are supported on the surface of the tin oxide-based particles (that is, the outer surface of the tin oxide-based particles or the inner surface of the mesopores).

When the Pt-based fine particles are composed of a Pt alloy, the composition of the Pt alloy (meaning the kind and content of an alloy element) is not particularly limited and an optimum composition can be selected depending on the purpose. Examples of the Pt alloy include:
(a) alloys (for example, a Pt—Pd alloy, a Pt—Ru alloy, and a Pt—Ir alloy), each composed of Pt and one or more precious metal elements other than Pt,
(b) alloys (for example, a Pt—Fe alloy, a Pt—Co alloy, a Pt—Ni alloy, a Pt—Cr alloy, a Pt—V alloy, and a Pt—Ti alloy), each composed of Pt and one or more base metal elements (for example, Fe, Co, Ni, Cr, V, and Ti).

### [B. Average Particle Diameter]

The term “average particle diameter of Pt-based fine particles” means the average of the maximum diameter of Pt-based fine particles as measured by scanning electron microscope (SEM) observation.

The average particle diameter of Pt-based fine particles has an influence on mass activity. In general, Pt-based fine particles having a too large average particle diameter have deteriorated mass activity. The average particle diameter of the Pt-based fine particles is therefore desirably 5 nm or less. The average particle diameter is more desirably 4 nm or less.

On the contrary, when Pt-based fine particles have a too small average particle diameter, a component constituting the fine particles such as Pt is likely to elute. The average particle diameter of the Pt-based fine particles is therefore desirably 1 nm or more. The average particle diameter is more desirably 2 nm or more.

### [C. Supported Amount]

The supported amount of the Pt-based fine particles is not particularly limited and the optimum supported amount may be selected, depending on the purpose. In general, when the supported amount of the Pt-based fine particles becomes too small, the thickness of a catalyst layer necessary for achieving a predetermined weight per area increases and therefore the resulting catalyst layer has increased electronic resistance, proton transfer resistance, and/or gas diffusion resistance. The supported amount of the Pt-based fine particles is therefore desirably 5 mass % or more. The supported amount is more desirably 10 mass % or more and yet more desirably 15 mass % or more.

On the contrary, when the supported amount of the Pt-based fine particles becomes excessively large, aggregation of the Pt-based fine particles occurs on the support surface and the resulting electrode catalyst has rather deteriorated activity. The supported amount of the Pt-based fine particles is therefore desirably 60 mass % or less. The supported amount is more desirably 50 mass % or less and yet more desirably 40 mass % or less.

### [1.2. Ionomer]

In the catalyst layer according to the present invention, the material of an ionomer is not particularly limited. Examples of the ionomer include perfluorocarbon sulfonic acid polymers and high oxygen permeable ionomers. As the ionomer, any one of them may be used or two or more of them may be used in combination.

The term “perfluorocarbon sulfonic acid polymers” means fluorine-containing ion exchange resins containing repeating units based on a sulfonyl fluoride vinyl ether monomer. Examples of the perfluorocarbon sulfonic acid polymers include Nafion (trademark), Flemion (trademark), Aquivion (trademark), and Aciplex (trademark).

The term “high oxygen permeable ionomer” means a polymer containing, in the molecular structure thereof, an acid group and a cyclic structure. Since the high oxygen permeable ionomer contains, in the molecular structure thereof, a cyclic structure, it has a high oxygen permeability coefficient. Using it as an ionomer, therefore, relatively reduces the oxygen transfer resistance at the interface with the catalyst.

In other words, the term “high oxygen permeable ionomer” means an ionomer having an oxygen permeability coefficient higher than that of perfluorocarbon sulfonic acid polymers typified by Nafion (trademark).

Examples of the high oxygen permeable ionomer include:
(a) electrolyte polymers containing a perfluorocarbon unit having an alicyclic structure and an acid group unit having perfluorosulfonic acid in the side chain;
(b) electrolyte polymers containing a perfluorocarbon unit having an alicyclic structure and an acid group unit having perfluoroimide in the side chain, and
(c) electrolyte polymers containing a unit in which perfluorosulfonic acid is directly bonded to perfluorocarbon having an alicyclic structure (refer to the following Reference Literatures 1 to 4).
[Reference Literature 1] Japanese Unexamined Patent Application Publication No. 2003-036856
[Reference Literature 2] WO2012/088166
[Reference Literature 3] Japanese Unexamined Patent Application Publication No. 2013-216811
[Reference Literature 4] Japanese Unexamined Patent Application Publication No. 2006-152249

### [1.3. I/S]

The term “I/S” means a ratio of the mass (I) of the ionomer to the mass (S) of the tin oxide-based particles, each contained in the catalyst layer.

The I/S has an influence on the proton conductivity and/or gas diffusivity of the catalyst layer. In general, when the I/S becomes too small, the resulting catalyst layer has decreased proton conductivity. The I/S is therefore desirably 0.13 or more. The I/S is more desirably 0.20 or more.

On the contrary, when the I/S becomes too large, the resulting catalyst layer has decreased gas diffusivity due to a reduction in the volume of the voids in the catalyst layer. The I/S is therefore desirably 0.39 or less. The I/S is more desirably 0.33 or less.

### [1.4. Characteristics]

### [1.4.1. Mass Activity Under High Humidity Conditions]

The tam “mass activity under high humidity conditions” means the oxygen-reduction-reaction mass activity when a polymer electrolyte fuel cell is formed using the catalyst layer of the present invention as a cathode (an air electrode) and power is generated under the following conditions: cell temperature: 60° C., gas relative humidity (both electrodes): 80%, oxygen partial pressure in a cathode gas: 21 kPa, and cell voltage: 0.86 V.

The optimization of the pore diameter of the tin oxide-based particles improves the mass activity under high humidity conditions. This is probably because by the optimization of the pore diameter, Pt-based fine particles are likely to be supported in pores and at the same time, the Pt-based fine particles in the pores are hardly poisoned by the ionomer. When the microstructure of the tin oxide-based particles is optimized, the mass activity under high humidity conditions becomes 90 A/g_{Pt} or more, or 150 A/g_{Pt} or more.

The catalyst layer according to the present invention has however low mass activity under high humidity conditions compared with a conventional catalyst layer using Pt/C for an electrode catalyst. This is probably because since the surface of the tin oxide-based particles is hydrophilic, whereas the surface of carbon particles is hydrophobic, the catalyst layer using the tin oxide-based particles for a support tends to cause flooding under high humidity conditions compared with the catalyst layer using the carbon support.

### [1.4.2. Mass Activity Under Low Humidity Conditions]

The tam “mass activity under low humidity conditions” means the oxygen-reduction-reaction mass activity when a polymer electrolyte fuel cell is formed using the catalyst layer of the present invention as a cathode (an air electrode) and power is generated under the following conditions: cell temperature: 82° C., gas relative humidity (both electrodes): 30%, oxygen partial pressure in a cathode gas: 21 kPa, and cell voltage: 0.86 V.

The catalyst layer according to the present invention sometimes has higher mass activity under low humidity conditions, compared with a conventional catalyst layer using Pt/C for an electrode catalyst. This is probably because the tin oxide-based particles have a hydrophilic surface so that water necessary for proton conduction is likely to exist in the vicinity of the Pt-based particles even under low humidity conditions.

The optimization of the pore diameter of tin oxide-based particles further improves the mass activity under low humidity conditions. This is probably because by the optimization of the pore diameter, the Pt-based fine particles are likely to be supported in pores and at the same time, the Pt-based fine particles in the pores are hardly poisoned by the ionomer. By optimizing the microstructure of the tin oxide-based particles, the mass activity under low humidity conditions becomes 150 A/g_{Pt} or more, or 200 A/g_{Pt} or more.

### [1.4.3. ECSA Reduction Ratio]

The term “ECSA reduction ratio” means a value represented by the following formula (1):

ECSA reduction ratio=(ECSA₀−ECSA₂₀₀₀)×100/ECSA₀ (1) wherein:
ECSA₀ is ECSA immediately after the manufacture of a polymer electrolyte fuel cell using the catalyst layer of the present invention as a cathode (an air electrode), and
ECSA₂₀₀₀ is ECSA after the polymer electrolyte fuel cell is subjected to a high-potential cycle endurance test (1.0↔1.5 V, 2000 cycles).

Compared with a conventional catalyst layer using Pt/C for an electrode catalyst, the catalyst layer according to the present invention has a smaller ECSA reduction ratio. This is probably because the carbon support is oxidized at a high potential and Pt particles supported thereon fall off, while a tin oxide support has high stability at a high potential and falling off of the Pt particles hardly occurs. In the tin oxide-based particles having an optimized structure, the ECSA reduction ratio becomes 5% or less, 3% or less, or 1% or less.

### [2. Method of Manufacturing Mesoporous Silica (First Template)]

The tin oxide-based particles can be manufactured using various methods. Particularly for the manufacture of tin oxide-based particles having a connected structure, it is necessary to manufacture mesoporous silica (first template) having a connected structure. Such mesoporous silica can be obtained by:
(a) polycondensing a silica source in a reaction solution containing the silica source, a surfactant, and a catalyst and thereby preparing precursor particles,
(b) separating the precursor particles from the reaction solution and drying the former one,
(c) subjecting the dried precursor particles to diameter expansion treatment if necessary, and
(d) baking the resulting precursor particles.

### [2.1. Polycondensation Process]

Firstly, precursor particles are obtained by polycondensing a silica source in a reaction solution containing the silica source, a surfactant, and a catalyst (polycondensation process).

### [2.1.1. Silica Source]

In the present invention, the type of a silica source is not particularly limited. Examples of a silica source are:
(a) tetraalkoxysilanes such as tetramethoxysilane, tetraethoxysilane, tetraisopropoxysilane, tetrabutoxysilane, dimethoxydiethoxysilane, and tetraethylene glycoxysilane; and
(b) trialkoxysilanes such as 3-mercaptopropyltrimethoxysilane, 3-aminopropyltrimethoxysilane, 3-aminopropyltriethoxysilane, and 3-(2-aminoethyl)aminopropyltrimethoxysilane.
   As a silica source, any one of those may be used or two or more of them may be used in combination.

### [2.1.2. Surfactant]

In the case of polycondensing a silica source in a reaction solution, when a surfactant is added to the reaction solution, the surfactant forms a micelle in the reaction solution. Since hydrophilic groups are gathered around the micelle, the silica source is adsorbed on the surface of the micelle. Further, the micelle adsorbing the silica source self-organizes in the reaction solution and the silica source is polycondensed. As a result, mesopores due to the micelle are formed in primary particles. The size of the mesopores can be controlled (1 to up to 50 nm) mainly by the molecular length of the surfactant.

In the present invention, alkyl quaternary ammonium salt is used as a surfactant. The alkyl quaternary ammonium salt is a chemical compound represented by the following expression;

CH₃—(CH₂)ₙ—N⁺(R₁)(R₂)(R₃)X⁻ (a).

In the expression (a), R₁, R₂, and R₃ represent alkyl groups each of which has a carbon number of 1 to 3, respectively. R₁, R₂, and R₃ may be the same as or different from each other. In order to facilitate the aggregation of alkyl quaternary ammonium salts (formation of micelle), it is desirable that all of R₁, R₂, and R₃ are the same. Further, it is desirable that at least one of R₁, R₂, and R₃ is a methyl group and more desirable that all of R₁, R₂, and R₃ are a methyl group.

In the expression (a), X represents a halogen atom. Type of the halogen atom is not particularly limited but it is desirable that X is Cl or Br for the reason of availability.

In the expression (a), n represents an integer of 7 to 21. Generally, as n is smaller, a spherical mesoporous material in which the central pore diameter of mesopores is smaller is obtained. On the other hand, as n is larger, the central pore diameter is larger. If n is too large, however, hydrophobic interaction of the alkyl quaternary ammonium salt becomes excessive. As a result, a layered compound is generated and a mesoporous material is not obtained. n is desirably 9 to 17 and more desirably 13 to 17.

Among the substances represented by the expression (a), alkyltrimethylammonium halide is desirable. Examples of alkyltrimethylammonium halide are hexadecyltrimethylammonium halide, octadecyltrimethylammonium halide, nonyltrimethylammonium halide, decyltrimethylammonium halide, undecyltrimethylammonium halide, and dodecyltrimethylammonium halide.

Among them, alkyltrimethylammonium bromide or alkyltrimethylammonium chloride is particularly desirable.

In the case of synthesizing mesoporous silica, one or two or more kinds of alkyl quaternary ammonium salts may be used. However, since an alkyl quaternary ammonium salt becomes a template for forming mesopores in primary particles, the type largely influences the shapes of the mesopores.

In order to synthesize silica particles having more uniform mesopores, it is desirable to use one kind of alkyl quaternary ammonium salt.

### [2.1.3. Catalyst]

When a silica source is polycondensed, usually a catalyst is added in a reaction solution. In the case of synthesizing particulate mesoporous silica, alkali such as sodium hydroxide or ammonia water or acid such as hydrochloric acid may be used as a catalyst.

### [2.1.4. Solvent]

As a solvent, water, an organic solvent such as alcohol, a mixed solvent of water and an organic solvent, or the like is used.

As the alcohol, any one of
(1) monohydric alcohol such as methanol, ethanol, and propanol,
(2) divalent alcohol such as ethylene glycol, and
(3) trivalent alcohol such as glycerin may be acceptable.

In the case of using the mixed solvent of water and an organic solvent, the content of the organic solvent in the mixed solvent can be selected arbitrarily depending on the purpose. In general, addition of an adequate amount of the organic solvent to the solvent facilitates control of a particle diameter or particle diameter distribution.

### [2.1.5. Composition of the Reaction Solution]

The composition of the reaction solution has an influence on the external appearance or pore structure of the mesoporous silica thus synthesized. In particular, the concentration of the surfactant and the concentration of the silica source, each in the reaction solution, have a large influence on the average primary particle diameter, the pore diameter, the pore volume, and the tap density of the mesoporous silica particles.

### [A. Concentration of the Surfactant]

When the concentration of the surfactant is too low, the precipitation rate of the particles decreases and a structure in which primary particles are connected to each other cannot be obtained. The concentration of the surfactant is therefore required to be 0.03 mol/L or more. The concentration of the surfactant is desirably 0.035 mol/L or more and more desirably 0.04 mol/L or more.

On the contrary, when the concentration of the surfactant is too high, the precipitation rate of the particles excessively increases and the primary particle diameter easily exceeds 300 nm. The concentration of the surfactant is therefore required to be 1.0 mol/L or less. The concentration of the surfactant is desirably 0.95 mol/L or less and more desirably 0.90 mol/L or less.

### [B. Concentration of the Silica Source]

When the concentration of the silica source is too low, the precipitation rate of the particles decreases and a structure in which primary particles are connected to each other cannot be obtained, or the content of the surfactant becomes excessively large and uniform mesopores cannot always be obtained. The concentration of the silica source is therefore required to be 0.05 mol/L or more. The concentration of the silica source is desirably 0.06 mol/L or more and more desirably 0.07 mol/L or more.

On the contrary, when the concentration of the silica source is too high, the precipitation rate of the particles excessively increases and the primary particle diameter easily exceeds 300 nm, or not spherical particles but sheet-like particles are sometimes obtained. The concentration of the silica source is therefore required to be 1.0 mol/L or less. The concentration of the silica source is desirably 0.95 mol/L or less and more desirably 0.9 mol/L or less.

### [C. Concentration of Catalyst]

In the present invention, a concentration of a catalyst is not particularly limited. Generally, if a concentration of a catalyst is too low, the precipitation rate of particles becomes low. On the other hand, if a concentration of a catalyst is too high, the precipitation rate of particles becomes high. It is desirable to select an optimum concentration of a catalyst in accordance with the type of a silica source, the type of a surfactant, a targeted physical property value, and others.

### [2.1.6. Reaction Conditions]

Hydrolysis and polycondensation are performed by adding a silica source in a solvent containing a predetermined amount of surfactant. Consequently, the surfactant functions as a template and precursor particles containing silica and the surfactant are obtained.

With regard to reaction conditions, optimum conditions are selected in accordance with the type of a silica source, the particle diameters of the precursor particles, and others. Generally, a desirable reaction temperature is −20° C. to 100° C. A reaction temperature is more desirably 0° C. to 90° C., and still more desirably 10° C. to 80° C.

### [2.2. Drying Process]

Successively, the precursor particles are separated from the reaction solution and dried (drying process).

The drying is applied in order to remove the solvent remaining in the precursor particles. The drying condition is not particularly limited as long as the solvent can be removed.

### [2.3. Diameter Expansion Treatment]

Successively, diameter expansion treatment may be applied to the dried precursor particles if necessary (diameter expansion process). The “diameter expansion treatment” means a treatment of expanding the diameters of mesopores in primary particles.

Specifically, the diameter expansion treatment is applied by hydrothermally heat-treating the synthesized precursor particles (particles from which the surfactant is not removed) in a solution containing a diameter expander. By this treatment, it is possible to expand the pore diameters of the precursor particles.

Examples of a diameter expander are:
(a) hydrocarbons such as trimethylbenzene, triethylbenzene, benzene, cyclohexane, triisopropylbenzene, naphthalene, hexane, heptane, octane, nonane, decane, undecane, and dodecane; and
(b) acids such as hydrochloric acid, sulfuric acid, and nitric acid.

Pore diameters are expanded by hydrothermal treatment under the coexistence of hydrocarbon. This is probably because silica rearrangement occurs when a diameter expander is introduced from a solvent into pores of more hydrophobic precursor particles.

Further, pore diameters are expanded by hydrothermal treatment under the coexistence of acid such as hydrochloric acid. This is probably because dissolution/reprecipitation of silica progresses in the interiors of primary particles. When manufacturing conditions are optimized, radial pores are formed in the interior of silica. When hydrothermal treatment is applied to it under the coexistence of acid, dissolution/reprecipitation of silica occurs and the radial pores are converted to communicating pores.

The conditions of the diameter expansion treatment are not particularly limited as long as target pore diameters can be obtained. Usually, it is desirable to add a diameter expander of about 0.05 mol/L to 10 mol/L to a reaction solution and apply hydrothermal treatment at 60° C. to 150° C.

### [2.4. Baking Process]

Successively, after the diameter expansion treatment is performed if necessary, the precursor particles are baked (baking process). By this process, mesoporous silica particles having a connected structure are obtained.

The baking is performed to dehydrate/crystallize the precursor particles having a residual OH group and to thermally decompose the surfactant remaining in the mesopores. The baking conditions are not particularly limited as long as the dehydration/crystallization and thermal decomposition of the surfactant can be performed. Usually, the baking is performed by heating the precursor particles at 400° C. to 700° C. for 1 to 10 hours in the atmosphere.

### [3. Method of Manufacturing Mesoporous Carbon (Second Template)]

Successively, mesoporous carbon (second template) having a connected structure is manufactured using the mesoporous silica having a connected structure as a template. Such mesoporous carbon can be obtained by:
(a) preparing mesoporous silica acting as a first template,
(b) precipitating carbon in the mesopores of the mesoporous silica to prepare a silica/carbon complex, and
(c) removing silica from the complex.

In order to accelerate graphitization of the resulting mesoporous carbon, the mesoporous carbon may be heat treated at a temperature higher than 1500° C. after removal of silica.

### [3.1. First Template Preparation Process]

First, mesoporous silica which will serve as a first template is prepared (first template preparation process). The details of the method of manufacturing mesoporous silica have already been described above so that a description on them is omitted.

### [3.2. Carbon Precipitation Process]

Successively, carbon is precipitated in the mesopores of the mesoporous silica to prepare a silica/carbon complex (carbon precipitation process).

Described specifically, the precipitation of carbon in the mesopores is performed by:
(a) introducing a carbon precursor into mesopores; and
(b) polymerizing and carbonizing the carbon precursor in the mesopores.

### [3.2.1. Introduction of Carbon Precursor]

A “carbon precursor” means a substance that can produce carbon by thermal decomposition. Concrete examples of such a carbon precursor are:
(1) a thermopolymerizable polymer precursor that is a liquid at room temperature (for example, furfuryl alcohol, aniline, etc.);
(2) a mixture of an aqueous solution of carbohydrate and acid (for example, a mixture of a monosaccharide such as sucrose, xylose, or glucose, a disaccharide, or a polysaccharide and acid such as sulfuric acid, hydrochloric acid, nitric acid, or phosphoric acid); and
(3) a mixture of two-component curable polymer precursors (for example, phenol and formalin).

Among those, a polymer precursor can be impregnated into mesopores without being diluted with a solvent and hence can generate a relatively large amount of carbon in mesopores with a relatively small number of impregnations. Further, it has the advantages of not requiring a polymerization initiator and being easy to handle.

When a carbon precursor of a liquid or a solution is used, the larger the amount of the liquid or the solution adsorbed at one time, the better, and an amount that allows the entire mesopores to be filled with the liquid or the solution is preferable.

Further, when a mixture of an aqueous solution of a carbohydrate and acid is used as a carbon precursor, it is preferable that the amount of the acid is a minimum amount that can polymerize an organic matter.

Furthermore, when a mixture of two-component curable polymer precursors is used as a carbon precursor, an optimum ratio is selected in accordance with the types of the polymer precursors.

### [3.2.2. Polymerization and Carbonization of Carbon Precursor]

Successively, the polymerized carbon precursor is carbonized in the mesopores.

The carbonization of the carbon precursor is performed by heating mesoporous silica containing the carbon precursor to a predetermined temperature in a non-oxidizing atmosphere (for example, in an inert atmosphere or in vacuum). A desirable heating temperature is concretely 500° C. or higher to 1,200° C. or lower. If the heating temperature is lower than 500° C., the carbonization of the carbon precursor becomes insufficient. On the other hand, if the heating temperature exceeds 1,200° C., silica reacts with carbon undesirably. As the heating time, an optimum time is selected in accordance with the heating temperature.

Here, the amount of carbon generated in mesopores may be any amount as long as the amount is not less than an amount of allowing carbon particles to maintain their shapes when mesoporous silica is removed. When the amount of carbon generated through a single filling, polymerization, and carbonization is relatively small therefore, it is desirable to repeat those processes multiple times. On this occasion, the conditions of repeated processes may be the same or different.

Further, when the processes of filling, polymerization, and carbonization are repeated multiple times, in the carbonization process, it is also possible to apply carbonization treatment at a relatively low temperature and, after the last carbonization treatment is finished, apply carbonization treatment again at a temperature higher than the previous temperature. When the last carbonization treatment is applied at a temperature higher than the temperature of the previous carbonization process, it becomes easier to integrate the carbon introduced into the pores in multiple times.

### [3.3. First Template Removal Process]

Successively, the mesoporous silica serving as the first template is removed from the complex (first template removal process). By this removal, mesoporous carbon (second template) having a connected structure is obtained.

Concrete examples of a method of removing mesoporous silica include:
(1) a method of heating the complex in an aqueous solution of an alkali such as sodium hydroxide, and
(2) a method of etching the complex in an aqueous solution of hydrofluoric acid.

### [3.4. Graphitization Treatment Process]

Successively, mesoporous carbon is heat treated at a temperature higher than 1500° C. if necessary (graphitization process). In the case of carbonizing a carbon source in the mesopores of the mesoporous silica, the heat treatment temperature should inevitably be decreased to suppress a reaction between silica and carbon. The graphitization degree of carbon after carbonization treatment is low. In order to achieve a high graphitization degree, the mesoporous carbon is therefore desirably heat treated at a high temperature after removal of the first template.

Heat treatment at a too low temperature leads to insufficient graphitization. The heat treatment temperature is desirably more than 1500° C. The heat treatment temperature is desirably 1700° C. or higher. The heat treatment temperature is more desirably 1800° C. or higher.

On the other hand, an increase in the heat treatment temperature to more than necessary is not useful because of no difference in effect. The heat treatment temperature is therefore desirably 2300° C. or lower. The heat treatment temperature is more desirably 2200° C. or lower.

### [4. Method of Manufacturing Tin Oxide-Based Particles]

A method of manufacturing tin oxide-based particles having a connected structure includes:
a first process of preparing mesoporous carbon having a connected structure,
a second process of precipitating tin oxide or a dopant-containing tin oxide (which may also be called “Sn-containing oxide” collectively hereinafter) in the mesopores of mesoporous carbon to obtain an Sn-containing oxide/carbon complex, and
a third process of removing carbon from the Sn-containing oxide/carbon complex.

### [4.1. First Process]

First, mesoporous carbon having a connected structure is prepared (first process). Details of the method of manufacturing mesoporous carbon has already been described above so that a description on it is omitted.

### [4.2. Second Process]

Successively, an Sn-containing oxide is precipitated in the mesopores of mesoporous carbon (second process), by which an Sn-containing oxide/carbon complex is obtained.

Described specifically, the precipitation of an Sn-containing oxide in the mesopores is performed by introducing a precursor of an Sn-containing oxide in the mesopores and converting the precursor into the Sn-containing oxide.

### [4.2.1. Precursor]

Specific examples of the precursor for forming the Sn-containing oxide in the mesopores include:
(1) compounds which contain a metal element constituting the Sn-containing oxide, are soluble in a solvent, and are oxidized by dissolved oxygen in the solvent to cause precipitation, and
(2) compounds which contain a metal element constituting the Sn-containing oxide and can be thermally decomposed or hydrolyzed into a metal oxide.

Examples of the compound which can be oxidized by dissolved oxygen to cause precipitation include:
(1) divalent Sn-containing salts such as SnCl₂, and
(2) Nb-, Sb-, W-, Ta-, or Al-containing salts such as NbCl₅, SbCl₃, WCl₆, TaCl₅, or AlCl₃.

Examples of the compound which can be thermally decomposed or hydrolyzed into a metal oxide include:
(1) chlorides such as SnCl₄, SnCl₂, NbCl₅, SbCl₃, WCl₆, TaCl₅, and AlCl₃,
(2) alkoxides such as tungsten ethoxide (W(OC₂H₅)₆), Sn(OC₂H₅)₂, Sn(OC(CH₃)₃)₄, Nb(OC₂H₅)₅, Ta(OC₂H₅)₅, Sb(OC₂H₅)₃, and Al(OC₂H₅)₃,
(3) acetylacetonate salts such as tin acetylacetonate (Sn(CH₃COCHCOCH₃)₂) and Al(CH₃COCHCOCH₃)₃, and
(4) acetates such as Sn(CH₃COO)₂ and Sb(CH₃COO)₃.
   [4.2.2. Introduction of the Precursor into Mesopores]

When the precursor is in liquid form, it may be adsorbed in the pores of the mesoporous carbon as it is. Alternatively, a solution obtained by dissolving the precursor in an appropriate solvent may be adsorbed in the pores of the mesoporous carbon. When the precursor is dissolved in a solvent, the kind of the solvent and the concentration of the precursor are not particularly limited but most suited ones may be selected depending on the purpose.

[4.2.3. Conversion of the Precursor into an Oxide]

After adsorption, the resulting precursor is converted into an Sn-containing oxide. A conversion method is not particularly limited and the most suited method is selected, depending on the kind of the precursor.

For example, when the chloride is used as the precursor, mesoporous carbon is dispersed in a solution having the chloride dissolved therein, followed by stirring in the air. By continuing stirring, the chloride is then adsorbed in the mesopores of the mesoporous carbon and the chloride in the mesopores gradually becomes an Sn-containing oxide by dissolved oxygen.

For example, when the alkoxide is used as the precursor, the alkoxide or a solution having it dissolved therein is added to the mesoporous carbon to impregnate the mesopores with the alkoxide or the solution thereof. Heating of the resulting mixture to a predetermined temperature causes polycondensation of the alkoxide and then an Sn-containing oxide is famed in the mesopores.

Adsorption of the precursor and conversion into the Sn-containing oxide may be repeated multiple times if a single adsorption and conversion cannot forma sufficient amount of the Sn-containing oxide in the mesopores.

### [4.3. Third Process]

Successively, carbon is removed from the Sn-containing oxide/carbon complex (third process), by which the tin oxide-based particles according to the present invention can be obtained.

A method of removing carbon is not particularly limited and various methods can be used therefor. Examples of the method of removing carbon include:
(1) a method of heating the Sn-containing oxide/carbon complex under an oxidizing atmosphere, and
(2) a method of subjecting the Sn-containing oxide/carbon complex to oxygen plasma etching.

Removal conditions such as heating temperature and heating time are not particularly limited as long as they enable the complete removal of carbon without coarsening the crystallites of the Sn-containing oxide.

### [5. Effect]

The catalyst layer according to the present invention uses, as a support for supporting Pt-based fine particles thereon, tin oxide-based particles having a connected structure with a specific surface area of 30 m²/g or more (desirably, 60 m²/g or more). Particularly, under low humidity (30% RH) conditions, therefore, the catalyst layer according to the present invention shows higher ORR mass activity compared with a conventional catalyst layer using Pt/C as an electrode catalyst, by having tin oxide-based particles with an optimized pore diameter. Further, the catalyst layer according to the present invention has considerably high high-potential cycle endurance compared with the conventional catalyst layer.

When the tin oxide-based particles have pores of an appropriate size, the Pt-based fine particles are likely to be supported in the pores and at the same time, the Pt-based fine particles supported in the pores are not easily covered with the ionomer. As a result, it is presumed that the poisoning of the Pt-based fine particles by the acid group of the ionomer is inhibited and the resulting catalyst layer shows high ORR mass activity.

The surface of the carbon particles is hydrophobic but the surface of the tin oxide-based particles is hydrophilic so that even under low-humidity conditions, water is easily retained around the tin oxide-based particles. As a result, the catalyst layer using the tin oxide-based particles as a support is presumed to have improved ORR mass activity under low-humidity conditions, compared with the catalyst layer using a carbon support.

The support composed of the tin oxide-based particles not only shows relatively high electronic conductivity but also has high stability at a high potential and is resistant to oxidation corrosion, compared with the support composed of carbon particles. Therefore, the catalyst layer using the tin oxide-based particles as a support shows higher high-potential cycle endurance compared with the catalyst layer using a carbon support.

### EXAMPLES

### Examples 1 to 5

### [1. Preparation of a Sample]

### [1.1. Preparation of an Sb—SnO₂ Support]

### [1.1.1. Preparation of a Connected Starburst Silica]

To a mixed solvent of 4.6 g of methanol (MeOH) and 4.6 g of ethylene glycol (EG), was added 56.3 g of a 30 mass % aqueous cetyltrimethylammonium chloride solution and the resulting mixture was stirred at room temperature. To the resulting reaction mixture was added 8.8 g of 1M NaOH, followed by heating to 50° C. The solution thus obtained will hereinafter be called “first solution”.

Successively, 12.3 g of tetraethoxysilane (TEOS) was dissolved in a mixed solvent of 6.5 g of MeOH and 6.5 g of EG. The resulting solution will hereinafter be called “second solution”.

The second solution was added to the first solution heated to 50° C. After the resulting mixture became turbid, heating was stopped and stirring was conducted for 4 hours or more. After filtration and redispersion in purified water were repeated twice, the reaction mixture was dried at 45° C. Further, the dried powder thus obtained was baked at 550° C. for 6 hours in the atmosphere to obtain a connected mesoporous silica having radial pores (such mesoporous silica may hereinafter be called “Connected Starburst Silica, CSS”).

### [1.1.2. Preparation of a Connected Starburst Carbon]

0.5 g of CSS was weighed in a container made of PFA. Furfuryl alcohol (FA) was then added to the container in an amount corresponding to the pore volume of CSS to allow it to penetrate in the pores of CSS. The product thus obtained was heat treated at 150° C. for 24 hours to polymerize FA. Further, the product thus obtained was heat treated at 500° C. for 6 hours in a nitrogen atmosphere to promote carbonization of FA. After the aforesaid operation was repeated twice, the product thus obtained was heat treated further at 900° C. for 6 hours in a nitrogen atmosphere to obtain a CSS/carbon complex.

The complex thus obtained was immersed in a 12% HF solution for 4 hours to dissolve a silica component in the solution. After dissolution, filtration and washing were repeated and then drying was performed at 45° C. to obtain a connected mesoporous carbon having radial pores (such mesoporous carbon may hereinafter be called “Connected Starburst Carbon, CSC”). The CSC thus obtained had a BET specific surface area of 2122 m²/g, a pore volume of 1.3 mL/g, and a pore diameter of 2.2 nm.

### [1.1.3. Preparation of a Connected Mesoporous Sb—SnO₂]

### A. Examples 1, 2, and 4

After 0.12 g of SbCl₃ (99.9 mass %, product of FUJIFILM Wako Chemicals) was dissolved in 4 mL of concentrated hydrochloric acid (35 mass %, product of Fujifilm Wako Chemicals) and the resulting solution was diluted with 36 mL of purified water, 5.0 g of SnCl₂ (99.9 mass %, product of FUJIFILM Wako Chemicals) was added further to dissolve it in the diluted solution. 0.1 g of CSC was added to the resulting solution to disperse it therein. After the resulting dispersion was stirred at room temperature for 2 hours in the air, 200 mL of purified water was added and the resulting mixture was stirred for 4 hours in the air. Subsequently, filtration and redispersion in purified water were repeated twice, followed by drying at 45° C. to obtain a connected Sb—SnO₂/carbon complex.

The resulting connected Sb—SnO₂/carbon complex was treated in the air atmosphere at 320° C. for 24 hours to obtain blue connected mesoporous Sb—SnO₂. The doping amount of Sb of the resulting connected mesoporous Sb—SnO₂ was 5.6 at %. The mode pore diameter (most frequent value) determined from N₂ adsorption measurement was 4.4 nm (Example 1).

Then, the resulting product was treated further at 400° C. for 3 hours or 500° C. for 3 hours in the air atmosphere to obtain a connected mesoporous Sb—SnO₂ having a pore diameter of 5.7 nm (Example 2) or 11 nm (Example 4).

### B. Examples 3 and 5

After 0.03 g of SbCl₃ (99.9 mass %, product of FUJIFILM Wako Chemicals) was dissolved in 4 mL of concentrated hydrochloric acid (35 mass %, product of FUJIFILM Wako Chemicals) and the resulting solution was diluted with 36 mL of purified water, 5.0 g of SnCl₂ (99.9 mass %, product of FUJIFILM Wako Chemicals) was added further to dissolve it in the diluted solution. To the resulting solution was added 0.1 g of CSC to disperse it therein. After the resulting dispersion was stirred at room temperature for 2 hours in the air, 200 mL of purified water was added. The resulting mixture was stirred further in the air for 4 hours. Then, filtration and redispersion in purified water were repeated twice, followed by drying at 45° C. to obtain a connected Sb—SnO₂/carbon complex.

The connected Sb—SnO₂/carbon complex thus obtained was treated at 320° C. for 24 hours in the air atmosphere and then, treated further at 450° C. for 3 hours in the air atmosphere to obtain pale-blue connected mesoporous Sb—SnO₂. The doping amount of Sb of the resulting connected mesoporous Sb—SnO₂ was 2.5 at %. The mode pore diameter (most frequent value) determined from N₂ adsorption measurement was 7.3 nm.

### [1.2. Preparation of an Electrode Catalyst]

### 1.2.1. Examples 1, 2, and 4

Pt nanoparticles were supported on the connected mesoporous Sb—SnO₂ (pore diameter: 4.4 nm, 5.7 nm, or 11 nm) by a colloidal method.

First, 6 mL of a 0.4 M NaOH/EG solution was mixed with 6 mL of a 0.04 mM H₂PtCl₆ (product of FUJIFILM Wako Chemicals)/EG solution. The resulting mixture was heated at 160° C. for 3 minutes while stirring with a microwave synthesizer (Monowave 400, product of Anton Paar) to obtain a Pt nanoparticle colloid solution.

Successively, 126 mg of an Sb—SnO₂ powder was added to 8 mL of the resulting Pt nanoparticle colloid solution and the resulting mixture was stirred overnight at room temperature. Then, an operation consisting of adding 0.2 mL of 1 M HNO₃ and stirring at room temperature for one hour was repeated twice. Further, 0.5 mL of 1 M HNO₃ was added and the resulting mixture was stirred for one hour at room temperature. Then, filtration and redispersion in purified water were repeated twice. Finally, the resulting solid matter was vacuum dried at 70° C. to obtain Pt/Sb—SnO₂ (Pt supporting ratio: 20 mass %).

### 1.2.2. Examples 3 and 5

The Pt nanoparticles were supported on the connected mesoporous Sb—SnO₂ (pore diameter: 7.3 nm) by a colloidal method.

First, 6 mL of a 0.4 M NaOH/EG solution was mixed with 6 mL of a 0.04 mM H₂PtCl₆ (product of FUJIFILM Wako Chemicals)/EG solution. The resulting mixture was heated at 160° C. for 3 minutes while stirring with a microwave synthesizer (Monowave 400, product of Anton Paar) to obtain a Pt nanoparticle colloid solution.

Successively, 91.5 mg of an Sb—SnO₂ powder was added to 10 mL of the resulting Pt nanoparticle colloid solution and the resulting mixture was stirred overnight at room temperature. Then, an operation consisting of adding 0.25 mL of 1M HNO₃ and stirring at room temperature for one hour was repeated twice. Further, 0.625 mL of 1 M HNO₃ was added and the resulting mixture was stirred for one hour at room temperature. Then, filtration and redispersion in purified water were repeated twice. Finally, the resulting solid matter was vacuum dried at 70° C. to obtain Pt/Sb—SnO₂ (Pt supporting ratio: 30 mass %).

### [1.3. Preparation of a Catalyst Layer]

### 1.3.1. Examples 1, 2 and 4

60 mg of 20 mass % Pt/Sb—SnO₂ was weighed in a plastic container. To the container, 100 mg of purified water, 100 mg of ethanol, 8.4 mg of propylene glycol, and 58.9 mg of an ionomer dispersion (21.2 mass %, D2020) were added. The ionomer content was adjusted so that I/S be 0.26. Shaking (Digital Disruptor Genie, 3000 rpm, 2 min) and ultrasonic dispersing (Bioruptor, 5 min) of the resulting mixture were repeated three times alternately to prepare a catalyst ink.

The catalyst ink thus obtained was applied to a polytetrafluoroethylene (PTE'S) sheet with an applicator (gap height: 4 mil) and vacuum-dried at 80° C. for 2 hours to obtain a cathode catalyst layer sheet. The weight per area of platinum was 0.11 mg_{Pt}/cm² (Examples 1 and 4) or 0.12 mg_{Pt}/cm² (Example 2).

### 1.3.2. Examples 3 and 5

70 mg of 30 mass % Pt/Sb—SnO₂ was weighed in a plastic container. To the container were added 100 mg of purified water, 100 mg of ethanol, 8.4 mg of propylene glycol, and 60.4 mg of an ionomer dispersion (21.2 mass %, D2020). The ionomer content was adjusted so that I/S be 0.26. Shaking (Digital Disruptor Genie, at 3000 rpm, for 2 min) and ultrasonic dispersing (Bioruptor, for 5 min) of the resulting mixture were repeated three times alternately to prepare a catalyst ink.

The catalyst ink thus obtained was applied to a PTEE sheet with an applicator (gap height: 4 mil) and vacuum-dried at 80° C. for 2 hours to obtain a cathode catalyst layer sheet. The weight per area of platinum was 0.12 mg_{Pt}/cm² (Example 3) or 0.10 mg_{Pt}/cm² (Example 5).

### 1.3.3. Comparative Examples 1 and 2

32 mg of commercially available 27.5 mass % Pt/Vulcan (trademark) (TEC10V30E, product of Tanaka Precious Metals) was weighed in a plastic container. To the container were added 140 mg of purified water, 210 mg of ethanol, and 107.3 mg of an ionomer dispersion (21.2 mass %, D2020). The ionomer content was adjusted so that a ratio (I/C) of the mass of the ionomer to the mass of the carbon support be 1.0. Shaking (Digital Disruptor Genie, at 3000 rpm, for 2 min) and ultrasonic dispersing (Bioruptor, for 5 min) of the resulting mixture were repeated three times alternately to prepare a catalyst ink.

The catalyst ink thus obtained was applied to a PTEE sheet with an applicator (gap height: 4 mil) and vacuum-dried at 80° C. for 2 hours to obtain a cathode catalyst layer sheet. The weight per area of platinum was 0.11 mg_{Pt}/cm² (Comparative Example 1) or 0.10 mg_{Pt}/cm² (Comparative Example 2).

### [1.4. Preparation of a Membrane Electrode Assembly (MEA)]

In a manner similar to that of Comparative Example 1 except for the use of 30 mass % Pt/Ketjen (trademark) as an electrode catalyst, an anode catalyst layer sheet was prepared. The weight per area of platinum was adjusted to 0.05 mg_{Pt}/cm² and I/C was adjusted to 1.0. The cathode catalyst layer sheet and the anode catalyst layer sheet were each cut into a 1-cm square sheet and the catalyst layers thus cut out were transferred to a Nafion (trademark) membrane (NR211) by hot pressing. The hot-pressing conditions were set at 120° C., 0.89 kN/cm², and 5 minutes.

### [2. Evaluation of a Cell]

The MEA thus prepared was evaluated using a rectangular cell for 1 cm². As a diffusion layer, carbon paper with a microporous layer was used.

### [2.1. Cyclic Voltammetry]

Cyclic voltammetry (CV) was measured under the following conditions and data of the third cycle was adopted.

Cell temperature/relative humidity (both electrodes): 60° C./80% RH or 82° C./30% RH

Cathode (air electrode) gas: N₂, 1000 mL/min, backpressure: 14.4 kPa-G Anode (fuel electrode) gas: 10% H₂, 500 mL/min, back pressure: 14.4 kPa-G

Potential sweep: sweeping three cycles at 50 mV/s from 0.1 V_{RHE} to 1.0 V_{RHE}.

### [2.2. Power Generation Performance Test]

An I-V curve was measured by potential sweep under the following conditions and forward-direction sweep (anodic scan) of the third cycle was adopted as I-V curve data:
Cell temperature/relative humidity (both electrodes): 60° C./80% RH or 82° C./30% RH,
Cathode (air electrode) gas: Air, 1000 mL/min, back pressure: 14.4 kPa-G,
Anode (fuel electrode) gas: H₂, 500 mL/min, back pressure: 14.4 kPa-G, and
Voltage sweep: sweeping three cycles at 20 mV/s from an open circuit voltage to 0.1 V.

### [2.3. CO Stripping Voltammetry]

CO stripping voltammetry was performed under the following conditions. From the electric charge of the CO oxidation peak of the CO stripping voltammogram thus obtained, an electrochemical surface area (ECSA) of Pt was calculated using a conversion factor of 420 μC/cm²_{Pt}.

Cell temperature/relative humidity (both electrodes): 60° C./80% RH or 82° C./30% RH.

Cathode (air electrode) gas: N₂, 1,000 mL/min, back pressure: 14.4 kPa-G (5% CO and 400 mL/min during CO adsorption).

Anode (fuel electrode) gas: 10% H₂, 500 mL/min, back pressure: 14.4 kPa-G.

Potential: retained at 0.3 V_{RHE} during CO adsorption, followed by sweeping 2 cycles at 20 mV/s from 0.1 V_{RHE} to 1.0 V_{RHE} (retained for 2 minutes at 1.0 V_{RHE}).

### [2.4. High-Potential Cycle Test]

A potential cycle test was performed under the following conditions:
cell temperature/relative humidity (both electrodes): 80° C./100% RH,
Cathode (air electrode) gas: N₂, 1000 mL/min,
Anode (fuel electrode) gas: 10% H₂, 500 mL/min,
Potential sweep: sweeping was applied with 2000 cycles in total at 0.5 V/s from 1.0 V_{RHE} to 1.5V_{RHE}.

Before and after the aforesaid potential cycles and during the cycles (250, 500, and 1000 cycles), cyclic voltammetry (from 0.1 V_{RHE} to 1.0 V_{RHE}, 0.05 V/s, three cycles) was performed. From the electric quantity of a H_{upd} peak (desorption side) of the resulting cyclic voltammogram (CV), an electrochemical surface area (ECSA) of Pt was estimated using a conversion factor of 210 μC/cm²_{Pt}.

Before and after the aforesaid potential cycle test, an I-V curve was measured under the following conditions:
cell temperature/relative humidity (both electrodes): 80° C./100% RH,
Cathode (air electrode) gas: Air, 1000 mL/min, back pressure: 46.1 kPa-G,
Anode (fuel electrode) gas: H₂, 500 mL/min, back pressure: 46.1 kPa-G, and
voltage sweep: sweeping three cycles at 0.02 V/s from an open circuit voltage to 0.1 V.

### [3. Results]

### [3.1. Initial Performance]

Table 1 collectively shows specifications of the catalyst layers obtained in Examples 1 to 4 and Comparative Example 1. The initial performances of MEAs using these catalyst layers as a cathode were evaluated and compared.

TABLE 1

| | | Pore diameter | Specific surface | Pt supporting | Weight per |
|---|---|---|---|---|---|
| | | of support | area of support | ratio | area of Pt |
| | Support | [nm] | [m²g⁻¹ ] | [mass %] | [mgₚₜcm⁻²] |
| EXAMPLE 1 | Sb—SnO₂ | 4.4 | 179 | 20 | 0.11 |
| EXAMPLE 2 | Sb—SnO₂ | 5.7 | 131 | 20 | 0.12 |
| EXAMPLE 3 | Sb—SnO₂ | 7.3 | 161 | 30 | 0.12 |
| EXAMPLE 4 | Sb—SnO₂ | 11 | 93 | 20 | 0.11 |
| COMPARATIVE | Carbon | — | — | 27.5 | 0.11 |
| EXAMPLE 1 | | | | | |

### [3.1.1. ECSA]

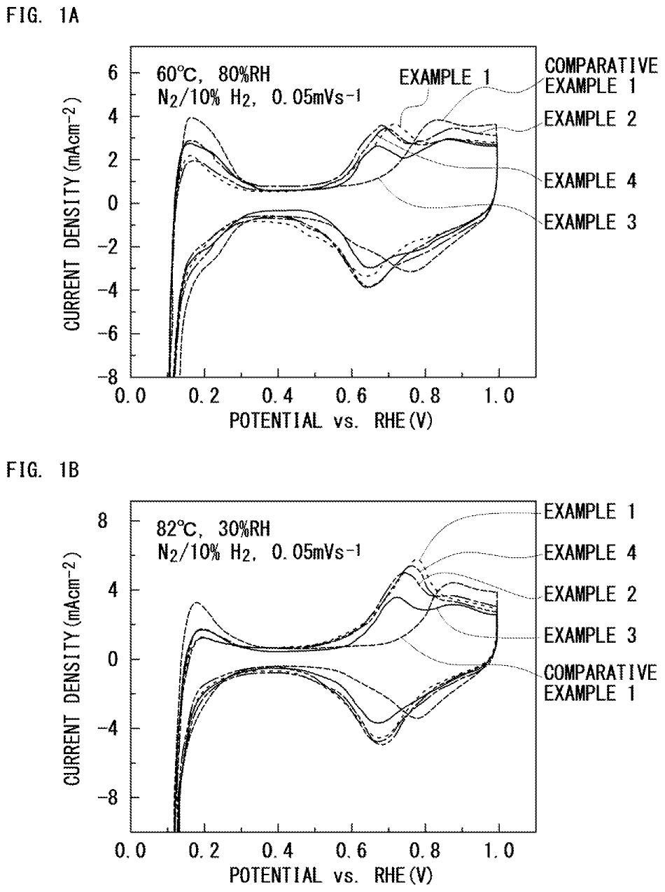

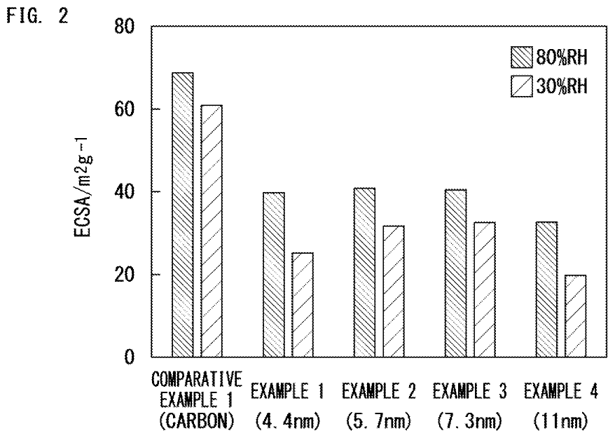

FIG. 1A shows a cyclic voltammogram of Pt/Sb—SnO₂ (Examples 1 to 4) and Pt/Vulcan (trademark) (Comparative Example 1) at 60° C. and 80% RH. FIG. 1B shows a cyclic voltammogram of Pt/Sb—SnO₂ (Examples 1 to 4) and Pt/Vulcan (trademark) (Comparative Example 1) at 82° C. and 30% RH. FIG. 2 shows the ECSA of Pt/Sb—SnO₂ (Examples 1 to 4) and Pt/Vulcan (trademark) (Comparative Example 1) determined from the CO stripping measurement.

The ECSA of the Pt/Sb—SnO₂ at 80% RH is about 30 to 40 m²/g_{Pt}, about half of that of Pt/Vulcan (trademark).

[3.1.2. I-v curve]

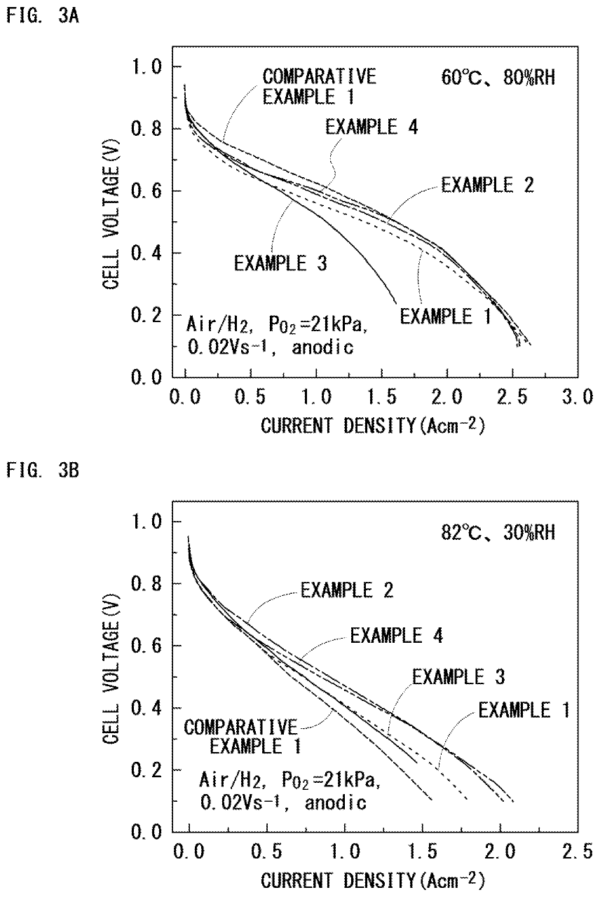

FIG. 3A shows an I-V curve of Pt/Sb—SnO₂ (Examples 1 to 4) and Pt/Vulcan (trademark) (Comparative Example 1) at 60° C. and 80% RH. FIG. 3B shows an I-V curve of Pt/Sb—SnO₂ (Examples 1 to 4) and Pt/Vulcan (trademark) (Comparative Example 1) at 82° C. and 30% RH.

At 80% RH, Pt/Vulcan (trademark) shows higher power generation performance than Pt/Sb—SnO₂ (particularly, in a region of 0.5 V or more). On the other hand, at 30% RH, Pt/Sb—SnO₂ shows a larger current density and higher power generation performance than Pt/Vulcan (trademark) at any cell voltage.

### [3.1.3. Mass Activity (MA) and Area Specific Activity (SA)]

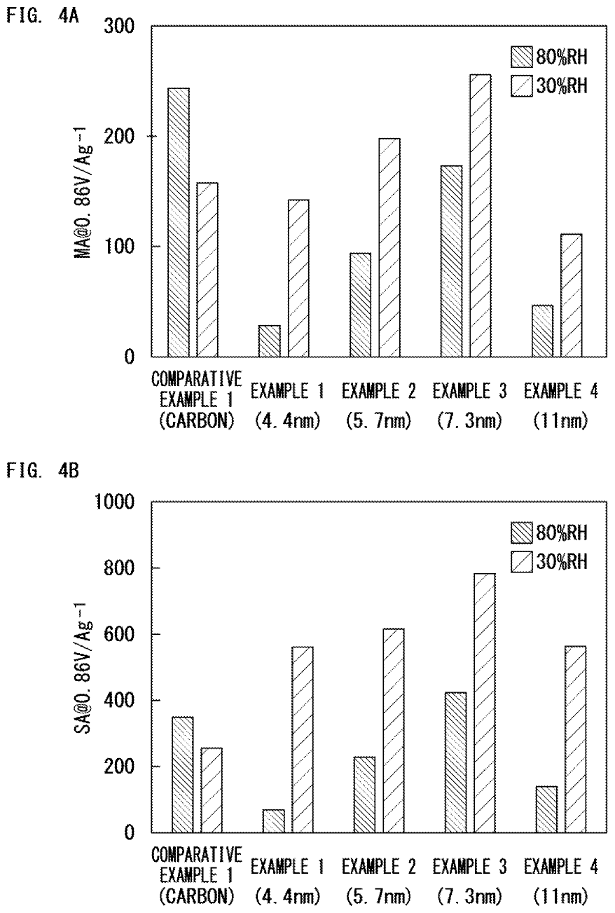

FIG. 4A shows ORR mass activity (MA) of Pt/Sb—SnO₂ (Examples 1 to 4) and Pt/Vulcan (trademark) (Comparative Example 1) at 0.86 V. FIG. 4B shows ORR area specific activity (SA) of Pt/Sb—SnO₂ (Examples 1 to 4) and Pt/Vulcan (trademark) (Comparative Example 1) at 0.86 V. It is to be noted that MA and SA in FIG. 4 were calculated using an IR compensation voltage obtained by the IR compensation of the cell voltage of FIG. 3.

The ORR mass activity of Pt/Sb—SnO₂ at 80% RH became lower than that of Pt/Vulcan (trademark). However, the mass activity of Pt/Sb—SnO₂ becomes the highest in the pore diameter of 7.3 mn, and when the pore diameter is smaller than 7.3 mn or larger than 7.3 mn, the mass activity of Pt/Sb—SnO₂ exhibits a decreasing trend. The reason why MA became highest at a pore diameter of 7.3 mn is presumably because since the Pt supported in the pores is not covered directly with an ionomer, poisoning of the catalyst by the sulfonic acid group of the ionomer is reduced.

When the pore diameter is too small, on the other hand, it is presumed that the Pt supporting method used this time does not allow the Pt particles to enter the pores and a proportion of the particles supported on the outside of the pores increases so that Pt is covered with the ionomer, leading to a decrease the effect of suppressing poisoning with the ionomer. When the pore diameter is too large, the ionomer enters the pores and some Pt particles are covered with the ionomer, leading to a decrease in the effect of suppressing poisoning with the ionomer.

Even at 30% RH, Pt/Sb—SnO₂ showed a similar tendency in the ORR mass activity. In addition, the ORR mass activity of Pt/Sb—SnO₂ at 30% RH was higher than that of Pt/Vulcan (trademark) when the pore diameter was 5.7 nm or 7.3 nm. This is presumably because the surface of the Sb—SnO₂ support is hydrophilic so that water is likely to be retained thereon and the proton conductivity in the vicinity of the Pt surface is higher than that of a carbon support.

### [3.2. Endurance Performance]

Table 2 collectively shows specifications of the catalyst layers obtained in Example 5 and Comparative Example 2. A high potential cycle endurance test was performed on MEAs using the aforesaid catalyst layers as a cathode and the results were compared.

TABLE 2

| | | Pore diameter | Pt supporting | Weight per |
|---|---|---|---|---|
| | | of support | ratio | area of Pt |
| | Support | [nm] | [mass %] | [mgₚₜcm⁻²] |
| EXAMPLE 5 | Sb—SnO₂ | 7.3 | 30 | 0.10 |
| COMPARATIVE | Carbon | — | 27.5 | 0.10 |
| EXAMPLE 2 | | | | |

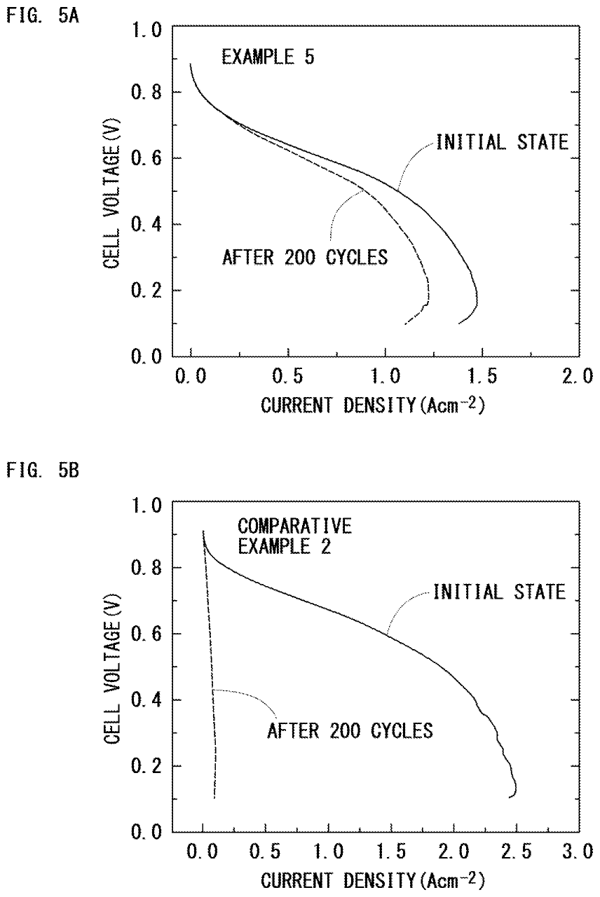

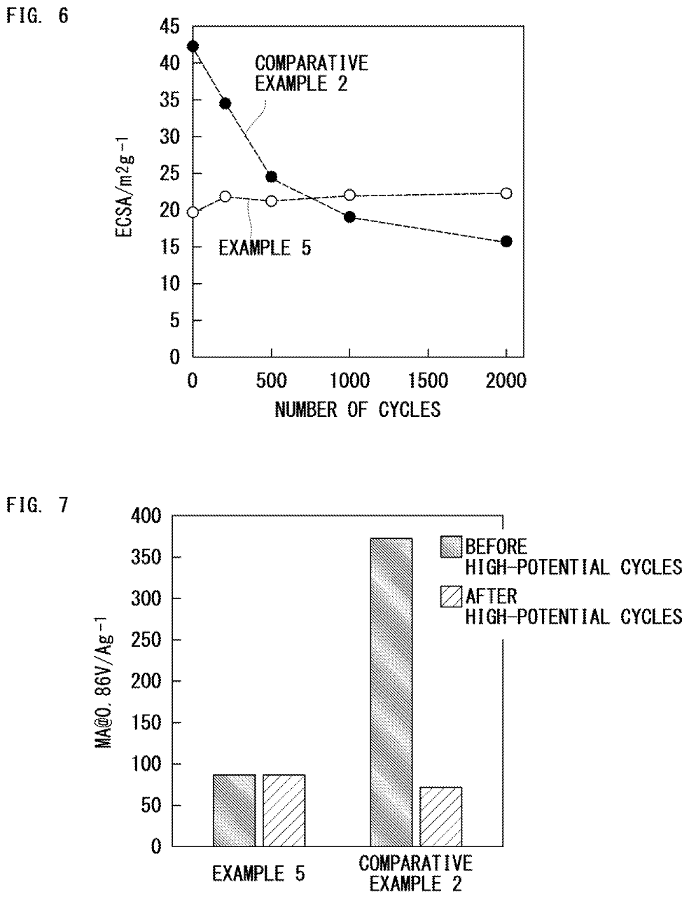

FIG. 5A shows an I-V curve of Pt/Sb—SnO₂ (0.10 mg_{Pt}/cm², Example 5) before and after the high-potential cycle test (2000 cycles). FIG. 5B shows an I-V curve of Pt/Vulcan (trademark) (0.10 mg_{Pt}/cm², Comparative Example 2) before and after the high-potential cycle test (2000 cycles). FIG. 6 shows the relationship between ECSA and the number of high-potential cycles of the cathode catalyst layer obtained in Example 5 and Comparative Example 2. FIG. 7 shows ORR mass activity of the cathode catalyst layer obtained in Example 5 and Comparative Example 2 at 0.86 V before and after the high-potential cycle test (2000 cycles).

After 2000 potential cycles, the ECSA of Pt/Vulcan (trademark) decreased to about ⅓ of the initial one, but no decrease was found from the ECSA of Pt/Sb—SnO₂. From these results, it was found that Pt/Vulcan (trademark) showed a remarkable decrease in both the ORR mass activity and power generation performance after the high potential cycle test, while Pt/Sb—SnO₂ showed almost no decrease in ORR mass activity and showed a relatively small decrease in power generation performance after the high-potential cycle test.

Details of the embodiments of the present invention have heretofore been described above, but the present invention is not limited by them at all and can be modified variously without departing from the gist of the present invention.

The catalyst layer according to the present invention can be used as a cathode (an air electrode) catalyst layer or an anode (a fuel electrode) catalyst layer of a polymer electrolyte fuel cell.

What is claimed is:

1. A catalyst layer, comprising:
an electrode catalyst, and
an ionomer,
wherein the catalyst electrode includes
tin oxide-based particles having a structure (connected structure) in which porous primary particles are connected to each other in a bead shape and having a specific surface are of 30 m²/g or more, and
Pt-based fine particles supported on the surface of the tin oxide-based particles.

2. The catalyst layer according to claim 1, wherein the tin oxide-based particles include Sb, Nb, Ta, and/or W-doped SnO₂.

3. The catalyst layer according to claim 1, wherein:
the tin oxide-based particles include Sb-doped SnO₂, and
a doping amount of Sb in the Sb-doped SnO₂ is 2.5 at % or more and 15.0 at % or less.

4. The catalyst layer according to claim 1, wherein a conductivity of a green compact composed of the tin oxide-based particles is 1×10⁻³ S/cm or more.

5. The catalyst layer according to claim 1, wherein an average particle diameter of the Pt-based fine particles is 5 nm or less.

6. The catalyst layer according to claim 1, wherein a ratio (=I/S) of a mass (I) of the ionomer to a mass (S) of the tin oxide-based particles is 0.13 or more and 0.39 or less.

7. The catalyst layer according to claim 1, wherein a pore diameter of the tin oxide-based particles is 5 nm or more and 8 nm or less.

8. The catalyst layer according to claim 1, wherein:
the tin oxide-based particles include Sb-doped SnO₂,
a specific surface area of the tin oxide-based particles is 90 m²/g or more, and
a pore diameter of the tin oxide-based particles is 5 nm or more and 8 nm or less.

9. The catalyst layer according to claim 1, wherein the mass activity under high-humidity conditions is 90 A/g_{Pt} or more,
provided that the term “mass activity under high-humidity conditions” means mass activity of an oxygen reduction reaction when a polymer electrolyte fuel cell is manufactured using the catalyst layer as a cathode (an air electrode) and power is generated under the following conditions: cell temperature: 60° C., gas relative humidity (both electrodes): 80%, oxygen partial pressure in a cathode gas: 21 kPa, and cell voltage: 0.86 V.

10. The catalyst layer according to claim 1, wherein the mass activity under low-humidity conditions is 150 A/g_{Pt} or more,
provided that the term “mass activity under low-humidity conditions” means mass activity of an oxygen reduction reaction when a polymer electrolyte fuel cell is manufactured using the catalyst layer as a cathode (an air electrode) and power is generated under the following conditions: cell temperature: 82° C., gas relative humidity (both electrodes): 30%, oxygen partial pressure in a cathode gas: 21 kPa, and cell voltage: 0.86 V.

11. The catalyst layer according to claim 1, wherein an ECSA reduction ratio represented by the following formula (1) is 5% or less:
ECSA reduction ratio=(ECSA₀−ECSA₂₀₀₀)×100/ECSA₀ (1)
provided that ECSA₀ is ECSA immediately after the manufacture of a polymer electrolyte fuel cell using the catalyst layer as a cathode (an air electrode); and
ECSA₂₀₀₀ is ECSA after the polymer electrolyte fuel cell is subjected to a high-potential cycle endurance test (1.0↔1.5 V, 2000 cycles).
